(19) United States
(12) Patent Application Publication
(10) Pub. No.: US 2018/0036654 A1
(43) Pub. Date: Feb. 8, 2018

(54) LAUNDER CHANNEL COVER WITH MAGNETIC LOCKING PANELS

(71) Applicant: Earle Schaller, Palm Beach Gardens, FL (US)

(72) Inventor: Earle Schaller, Palm Beach Gardens, FL (US)

(21) Appl. No.: 15/227,464

(22) Filed: Aug. 3, 2016

(51) Int. Cl. B01D 21/00; B01D 21/24

(52) U.S. Cl. CPC B01D 21/0003; B01D 21/2444

(57) ABSTRACT

A clarifier tank launder channel cover closure mechanism having a magnet, located at the top of a mounting bracket for supporting one side of a cover panel member, opposite its hinge mount across a launder channel of a clarifier tank. A magnetic element is attached to the cover panel member, and is located in corresponding location to the magnet, such that when the cover panel member is closed over the launder channel, the magnetic element and the magnet are in a mating relationship.

### RELATED APPLICATION

This application claims the benefit of priority from U.S. provisional patent application No. 62/200,683 filed on Aug. 4, 2015, the entirety of which is incorporated by reference.

### BACKGROUND

### Field of the Invention

This application relates to clarifier tank launder channel covers. More particularly, this application relates to latches for clarifier tank launder channel covers.

### Description of Related Art

In the area of waste treatment, clarifier tanks are used to separate solids from the water. Clarifier tanks typically receive influent water through the bottom. The solids settle towards the bottom of the tank with the cleaner water being forced upward and over into a launder channel.

Where the water spills into the launder channel, in some cases under a baffle and over a weir (fingered projections), there can be a buildup of algae and other contaminants. To correct this, in the prior art, an openable cover is usually placed over the launder channel/launder channel region to block the sunlight and to, among other things, inhibit algae growth. In making such arrangements to cover the launder channel around the entire upper circumference of the clarifier tank, the “cover” is usually comprised of numerous consecutive cover panel members.

Often there is a need to clean and inspect the channel and the components therein or nearby such as the scum baffle and weir. Depending on the mounting arrangement, the panel members may be hinged near the inner launder channel wall to open toward the center of the tank, or they may be hinged close to the outer wall and open back towards the outer wall. In either case, the panel members are usually held in place with a locking tab or latch, such as a swivel tab that must be turned by the operator before opening. Typically, this is not a problem when the panels are hinged near the inner launder channel wall and the locking tab is close to the outer wall where the operator would be walking during the cleaning.

However, when the panels are hinged close to the outer wall and open back toward the outer wall of the clarifier tank, the locking tab is usually located out by the opposing side of the panel members, near the inner launder channel wall and closer to the center of the tank. This makes it difficult for the operator to reach the latching mechanism for the panel members (while standing on the outer wall) and thus makes it difficult to safely open the panels for cleaning and inspection.

In some cases a clarifier tank may be built partially or totally above ground and access to the launder and the cover may be limited and require that a ladder be placed against the side of the tank to reach individual cover panel members. In those cases it may be difficult and potentially dangerous for the operator to reach over, press down on the spring loaded prior art handles and turn it to open the older style latches.

### Objects and Summary

The present arrangement provides a magnetic locking arrangement for a launder channel cover panel. Such an arrangement alleviates the need for twisting a locking tab, often located several feet away from the operator, while still being able to maintain the cover panels in a locked position during normal operation.

To this end, the present arrangement provides for a clarifier tank launder channel cover closure mechanism that has a magnet, located at the top of a mounting bracket for supporting one side of a cover panel member, opposite its hinge mount across a launder channel of a clarifier tank. A magnetic element is attached to the cover panel member, and is located in corresponding location to the magnet, such that when the cover panel member is closed over the launder channel, the magnetic element and the magnet are in a mating relationship.

### BRIEF DESCRIPTION OF THE DRAWINGS

The present invention can be best understood through the following description and accompanying drawings, wherein:

FIG. 1 shows a launder channel, cover panel member and magnetic locking arrangement in accordance with one embodiment;

FIG. 2 shows two angles of a cover panel member with an embedded steel plate in accordance with one embodiment;

FIG. 3 is an isolated view of the cover panel member mounting bracket with a magnet in accordance with one embodiment; and

FIG. 4 is a cut away view of a cover panel member magnetically closed in accordance with one embodiment.

### DETAILED DESCRIPTION

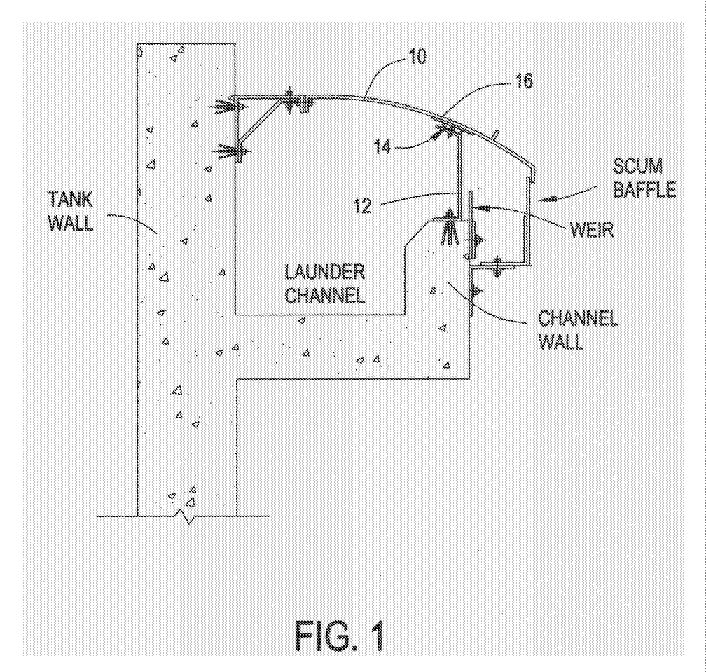

A cover panel 10 according to the present arrangement is shown in FIG. 1. Here cover panel 10 is hinged near the outer tank wall of the clarifier tank. At the inner launder channel wall is a mounting bracket 12 that supports the opposing side of cover panel 10.

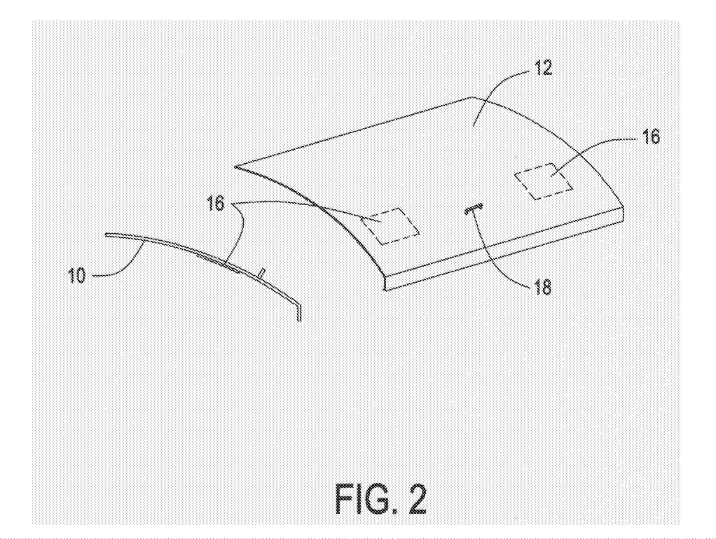

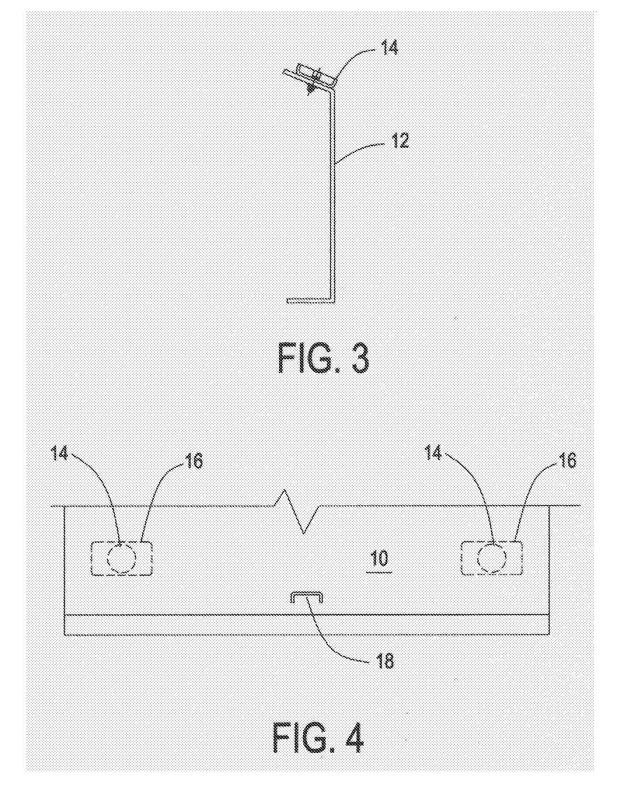

As shown in FIG. 1, mounting bracket 12 has a magnet 14 and panel member 10 has some form of aligning magnetic element 16, such as embedded steel plate (panels 10 are typically constructed of fiberglass). As shown in FIG. 2, near magnetic element 16 a lift handle 18 is provided. FIGS. 3 and 4 each show mounting bracket 12 and cover panel 10, respectively, in isolation.

In use, the operator can walk around the edge of the tank wall and when desired, can use a stick or hooked pole to reach over the channel/cover panel 10, connect with lift handle 18 and lift panel member 10 towards himself by simply breaking the magnetic seal, without the need to manipulate or swivel a locking tab.

It is noted that the example shown has the magnetic lock arrangement (14/16) in use with a panel member 10 that is hinged close to and opens towards the outer wall. However, it is noted that such a magnetic arrangement can be used with panel members 10 that are hinged at and open towards the launder channel wall if so desired.

The strength of magnet 14, and ultimately the size thereof, is determined by the weight of cover section 10 and the defining forces acting on the cover locally, including maximum expected wind speeds (such winds exerting an uplift force on cover 10). Magnet 14 must be sufficiently strong to withstand the uplift force, but not so strong that the operator is unable to lift cover 10. Typically, magnet 14 may have a lifting force between 25 and 90 pounds (relative attachment force in connection with magnetic element 16). Again, depending on the force required, a single magnet 14 may be located to contact the center of cover panel 10, or two magnets 14 may be spaced an equal distance from the center of panel 10 (as illustrated).

Because covers 10 are located outdoors, magnets 14 must be capable of withstanding moisture without rusting. For this reason, circular magnets sealed in a stainless steel mounting cup with epoxy coating are preferred. While only certain features of the invention have been illustrated and described herein, many modifications, substitutions, changes or equivalents will now occur to those skilled in the art. It is therefore to be understood that this application is intended to cover all such modifications and changes that fall within the true spirit of the invention.

What is claimed is:

1. A clarifier tank launder channel cover closure mechanism comprising:
a magnet, located at the top of a mounting bracket for supporting one side of a cover panel member, opposite its hinge mount across a launder channel of a clarifier tank;
a magnetic element attached to said cover panel member, and is located in corresponding location to said magnet, such that when said cover panel member is closed over said launder channel, said magnetic element and said magnet are in a mating relationship.

2. The clarifier tank launder channel cover closure mechanism as claimed in claim 1, wherein said mounting bracket is located at the launder channel wall.

3. The clarifier tank launder channel cover closure mechanism as claimed in claim 1, wherein said mounting bracket is located at the tank wall.

4. The clarifier tank launder channel cover closure mechanism as claimed in claim 1, wherein said magnetic element is bolted to said cover panel member.

5. The clarifier tank launder channel cover closure mechanism as claimed in claim 1, wherein said magnetic element is embedded within said cover panel member.

6. The clarifier tank launder channel cover closure mechanism as claimed in claim 1, wherein said magnet is a circular magnet sealed in a stainless steel mounting cup with epoxy coating.

7. The clarifier tank launder channel cover closure mechanism as claimed in claim 1, wherein said magnet/magnetic element attachment force is substantially 25-90 lbs.

8. The clarifier tank launder channel cover closure mechanism as claimed in claim 1, wherein each said cover panel member has one magnetic element located at a longitudinal (around circumference of clarifier tank) center position.

9. The clarifier tank launder channel cover closure mechanism as claimed in claim 1, wherein each said cover panel member has two magnetic elements located substantially equidistant from a longitudinal (around circumference of clarifier tank) center position.
